(19) United States
(12) Patent Application Publication
(10) Pub. No.: US 2006/0136295 A1
(43) Pub. Date: Jun. 22, 2006

(54) Techniques for magazine like presentation of advertisment using computers

(76) Inventors: Mark Bobick, Indialantic, FL (US); Carl Wimmer, Barbados, WI (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/283,641

(22) Filed: Nov. 21, 2005

Related U.S. Application Data
(60) Provisional application No. 60/630,432, filed on Nov. 23, 2004.

(51) Int. Cl. G06Q 30/00

(52) U.S. Cl. 705/14

(57) ABSTRACT

A computer implemented method and apparatus to persist user-context-sensitive consumer advertising impressions in a routinely persisted output object of a computer software application, wherein the user context is established by the contemporaneous program arguments supplied to a computer software application program by a user or the user context is established by contemporaneous user actions, the user context is captured by a software agent or integrated software component residing on a personal computing device, the software agent or integrated software component communicates the user context to an internet-based advertisement server, the internet-based advertisement server selects advertisements congruent with the supplied user context from an inventory of advertisements, the internet-based advertisement server returns the selected advertisements to the software agent or integrated software component residing on the personal computing device, and the software agent or integrated software component inserts the selected advertisements into the output object of a computer software application. The output object is then persisted by writing the contents of the output object to a non-volatile data storage device or non-volatile data storage media. The persisted output object of the computer software application, when so complemented by the inserted advertisements, is hereby termed a “magazine”.

### Cross Reference To Related Applications

This application claims priority to provisional application Ser. No. 60/630,432, filed on Nov. 23, 2004, entitled “Core Relations Development Corporation” the contents of which are hereby incorporated into this application by reference in their entirety.

### BACKGROUND OF THE INVENTION

1. Field of the Invention

The invention is related to information technology and, more particularly, to the presentation of magazine like advertising using computers.

2. Description of Related Art

Advertising is delivered over the Internet to computer users by utilizing several ubiquitous and well known mechanisms. Among those well known methods are pop-up ads and context-sensitive ads. Pop-up ads are sent to the computer user's Internet browser application, and are characterized by the creation and preemptive display of one or more browser sub-windows. Because the pop-up ad sub-windows overlay the current or expected content of the primary browser window, the display of the pop-up ad browser sub-window preempts the user's computer experience and workflow, typically requiring the user to actively close the pop-up ad browser sub-windows manually in order to return to the expected browser content and work task. Because the pop-up ad browser sub-window display is intrusive in this manner, because the pop-up ads are unsolicited, and because the user cannot prevent the preemptive display of pop-up ads with objectionable content, many computer users find pop-up ads unwelcome at best.

Because pop-up ads are unwelcome for these reasons, browser, ISP, and computer security software providers responded to market demand and have incorporated so-called “pop-up blockers” into their products. The pop-up blockers detect the imminent creation of a browser sub-window with technical characteristics typical of pop-up ads and intercept and halt the browser sub-window creation process. For example, most new browsers such as Netscape 7.2™ display an active “Pop Ups Blocked” indicator on the browser's toolbar. The running count of blocked pop-up ads is intended to inform the user of this service provided by the browser and such service is deemed to be valuable to the user.

As a consequence of a user employing the “pop-up blocker” features of the user's browser, ISP, or computer security software, the user is permanently prevented from ever viewing what may, in fact, be information the user could find to be of value or of interest.

Context-sensitive ads are delivered to computer users as part of web pages composed by application server software in the execution of a “web application”. Typical examples of application server software are “Java Server Pages”™, a product of Sun Microsystems, Inc., and “Active Server Pages”™, a product of Microsoft, Inc. Typical examples of “web applications” are the Google™ Search Engine, a product of Google, Inc., and the Amazon™ Store, a product of Amazon, Inc.

The time interval during which the user is interacting with [i.e. connected to] the web application is well known as a “session”. In a typical use for these examples, a user provides a context that explicitly or implicitly illuminates the user's immediate purpose and interest in using the web application. In the Google example, the context is provided by the search arguments presented by the user to the software [for example “French wine”]. In the example of the Amazon Store, the user context might be established by the user performing a price and availability check upon a certain book. In this case, the type of book (for example, science fiction), or the subject of the book (for example, monetary policy), are used to establish the user context. In other examples, additional facts about the user which may be known to the owner of the web application are also employed in a variety of well known and/or proprietary ways to establish a context. Such additional facts may include prior purchase history, account balance, zip code of residence, etc.

Once an explicit or potential user context is known, the selection of advertisements is made, based upon the perceived or actual proximity of the given user context to products, services, or lines of business of those commercial entities which have made commercial arrangements with the owner of the web application to have advertisements presented using this mechanism. In the Google example, the user context of “French wine” would be matched to advertisements from (for example) an online wine retailer, or a wine-interest printed periodical. In the Amazon example, the user context of science fiction would be matched to Amazon advertisements for other science fiction books and items, or those science fiction-themed items marketed by Amazon's commercial partners. Once advertisements have been selected, the features of the application server software are invoked to compose one or more web pages which make reference to or actually include the selected advertisements. The form of such advertisements, being only incident to the primary content of the composed web page, is typically small in terms of the percentage of page space devoted to each advertisement. Three formats of advertisement are typical, the three formats being “links” or text-only HTML references to web pages controlled by the advertiser, small “margin ads” which may be animated and appear along the left or right margins of the web page, or “banner ads” which may also be animated, but appear prominently along the top “header” or bottom “footer” margins of the web page. Variations of placement abound, but the size of the ads which contain graphical material is consistently small.

All context-sensitive ads in current practice as described above suffer from three significant limitations. First, the ads require active connection to the Internet in order to “lead” the user from the HTML link or small display ad to larger advertising display advertising content which can only be provided by the advertiser's own web application. Second, the user receives advertising impressions only for the duration of the web application “session”. Third, the advertising content object is a volatile and transient digital object that is not (and in some cases can not be) persisted to data storage media, and cannot therefore be “shared” with (i.e. a digital copy created and transmitted to) one or more third parties. The implicit user context or interest on the part of the third party or parties is known only to the original user, by means of social, occupational, educational, or personal association with the third party or parties, and can not be known to the owner of the web application or the owner's advertising partners.

Viral marketing has only recently come to be acknowledged as a potent mechanism for engendering the popular interest necessary for commercial success of many types of products, particularly entertainment media products, consumer products such as alcohol and tobacco, and technology products. Viral marketing is widely acknowledged to be characterized by at least six key elements. Viral marketing 1) gives away products or services; 2) provides for effortless transfer to others; 3) scales easily from small to very large; 4) exploits common motivations and behaviors; 5) utilizes existing communication networks, and 6) takes advantage of others' resources. The “communication network” that fuels most viral marketing efforts is the internet, and one [near] “effortless [mode of] transfer to others” is achieved by the sending of emails carrying marketing content to one or more recipients known to the sender. Typically, the recipients are known to the sender because the sender and the recipients jointly share social, occupational, educational, or personal associations.

Viral marketing content distributed under the typical circumstances herein described often consists of no more than a “link” or HTML reference to a web page sponsored by or created by the advertiser. Because the marketing content is often low in compelling visual appeal, viral marketers often must rely upon the additional comments from the sender in the body of the email to induce the email recipient to “click thru” to the advertiser's web page.

Adware technology is most frequently implemented using an independent software agent which installs itself on a personal computing device. Once installed, adware programs may exhibit behaviors ranging from the benign to the malicious. Some adware behavior is limited to contacting an internet-based advertisement server and having that server introduce pop-up ads on the user browser. Less benign adware programs have been documented to act as “spy ware”, or software that captures user activities (usually actions while connected to the internet) and then sending the collected information to sponsoring companies. There are many well-known cases of sponsoring companies using the collected information for unethical purposes. The most egregious examples of adware can damage the personal computing device file systems, choke the operation of the device with nearly unlimited and “un-killable” pop-up ads, or act as vehicles for introduction of computer viruses.

Because adware programs have exhibited these behaviors, an industry has developed around software to clear adware modules from personal computing devices. These adware cleaner companies maintain information about adware and spy ware currently in the market. They keep their software updated with the information, and clear the adware and spy ware when found.

Throughout their almost 200 year history, printed magazines have proven their popular appeal and the concomitant commercial viability of mixing advertising and editorial content. Some readers of a printed magazine view the editorial content only, while other readers view primarily the advertising content. In general, most magazines seek to create a style, placement, and respective percentage of representation for both editorial and advertising content, which will appeal to the unique reader interests upon which each magazine is able to specialize.

Printed magazines bring to advertisers many benefits which are not available with current implementations of pop-up ad technologies, context-sensitive ad web application technologies, and even viral marketing technologies. These benefits begin with the fact that reading printed magazines is a welcome and deliberately sought-after consumer experience, and for that reason, advertisements in printed magazines are not obliged to overcome any initial reader displeasure engendered by the method of the magazine's delivery. Tellingly, no products distinguish themselves by their ability to block the delivery of printed magazines. In addition, because the images and text of printed magazine advertisements are “persistent” [non-volatile and essentially indelible], printed magazine advertisements continue to deliver impressions to readers every time the magazine is opened. Considering the classic “dentist office” use of magazines, this benefit of printed magazines is of substantial value to advertisers. Even given the foregoing, printed magazines achieve currency with the immediate public and personal events and situations of readers. Printed magazines require no active or even occasional connection to the Internet. Finally, advertisements in printed magazines can take the form of large, multi-page display ads, with concomitant promotional impact upon readers. The present invention brings these benefits of printed magazines to the digital domains of pop-up, context-sensitive, and viral marketing advertisements.

### BRIEF SUMMARY OF THE INVENTION

The present invention discloses a method and apparatus for delivering user-context-sensitive consumer advertisements computer users that can deliver multiple impressions of each advertisement, in contrast to the single impression only that is possible with current pop-up ad technology. The present invention further improves upon current pop-up ad technology in that the advertisement presentation does not preempt or obstruct the computer user experience or workflow, but the advertisement is still delivered contemporaneously with the user's actual operation of the computer and computer software products resident thereupon. The present invention further improves upon current pop-up ad technology in that the delivered advertisements are not and can not be blocked by Internet Service Provider (ISP), browser, or computer security software products. The present invention is, in addition to being an improvement upon current pop-up ad technology, an improvement upon current context sensitive ad technology as typically implemented by search engines and other application server-enabled implementations in that the advertisements embedded in the output object are persisted past the termination of the user session established by the application server, thereby yielding additional advertising impressions for the advertiser.

### BRIEF DESCRIPTION OF THE DRAWINGS

FIG. 1 shows an exemplary system for distributing advertising in accordance with one aspect of the invention.

FIG. 2 shows a flowchart of software used in accordance with one aspect of the invention.

FIG. 3 shows a flowchart of software used to insert advertising into HTML output from an application in accordance with one aspect of the invention.

FIGS. 4A and 4B show alternative display options for displaying advertising.

FIG. 5 shows a flowchart of software used to insert advertising into HTML output from an application, even when offline, in accordance with one aspect of the invention.

FIG. 6 shows an exemplary graphical user interface for use in accordance with one aspect of the invention.

### DESCRIPTION OF THE INVENTION

The present invention discloses a method and apparatus for delivering user-context-sensitive consumer advertisements to personal computer users that can deliver multiple impressions of each advertisement, in contrast to the single impression only that is possible with current pop-up ad technology.

The present invention further improves upon current pop-up ad technology in that the advertisement presentation does not preempt or obstruct the computer user experience or workflow, but the advertisement is still delivered contemporaneously with the user's actual operation of the computer and computer software products resident thereupon.

The present invention further improves upon current pop-up ad technology in that the delivered advertisements are not and cannot be blocked by Internet Service Provider (ISP), browser, or computer security software products.

The present invention is, in addition to being an improvement upon current pop-up ad technology, an improvement upon current context sensitive ad technology as typically implemented by search engines and other application server-enabled implementations in that the advertisements embedded in the output object are persisted past the termination of the user session established by the application server, thereby yielding additional advertising impressions for the advertiser.

The present invention further improves upon current context sensitive ad technology in that the advertisements presented to the user do not require—subsequent to the original receipt of the advertisements by the software agent—an active connection to the internet in order to be viewed by the user (i.e. the advertisements can be viewed “off-line”).

The present invention is, in addition to being an improvement upon current pop-up ad technology and an improvement upon current context sensitive ad technology, an implementation of viral marketing technology (e.g. word of mouth advertising through a third party by use of the Internet), in that the output object can be shared with or sent to any number of persons known to the original user but not known to the internet-based advertisement server, and the advertisements embedded in the output object will be viewed by these additional recipients of the output object, thereby yielding additional advertising impressions for the advertiser.

The present invention is an improvement upon current viral marketing technology in that the digital content that is “virally” propagated through populations of users is comprised of the entire editorial component as well as the entire advertisement component, rather than a simple hyper-text link to a web page.

The present invention is, in addition to being an improvement upon current pop-up ad technology, an improvement upon current context sensitive ad technology, and an improvement upon current viral marketing technology, an improvement upon a related technology known as adware technology, in that in the integrated software component embodiment of the present invention the present invention is immune and exempt from removal by adware removal software, thereby yielding more consistent impression frequency for the advertiser. The present invention further improves upon adware technology in that in the integrated software component embodiment of the present invention, the user can be reassured that the interaction of the integrated software component and the internet-based advertisement server is restricted to the time interval that the computer software application is executing, and integrated software component is not, therefore, monitoring, recording, or “spying” upon the user's activities at other times (i.e. the present invention can not act as “spy ware”).

The present invention discloses a computer implemented method and apparatus to persist user-context-sensitive consumer advertising impressions in a routinely persisted output object of a computer software application. As described in the description of related art, the present invention discloses an improvement upon the prior art by realizing the well-known benefits of printed magazines in the digital domains of the prior art's pop-up, context-sensitive, and viral marketing advertisements. The majority of enablement for the present invention is well known:
The capture of a user context supplied to a computer software application program by a user, either by means of explicit program arguments entered by the user (see Google™ Search Engine, a product of Google, Inc.), by monitoring and examination of the user's activity within a computer application (see MS Word™ Help, a product of Microsoft, Inc.), or upon the computer generally (see Advanced KeyLogger, a product of Eltima, Inc.), or by utilizing additional facts about the user known to the advertiser (see Amazon™ Store, a product of Amazon, Inc.), is well known.
The use of one or more software agents, residing upon a personal computing device, to capture user context and/or monitor user activity (see Weather Bug™, a product of AWS Convergence Technologies, Inc.) is well known.
The use of an integrated software component of a computer software application, executing upon a personal computing device, to capture user context and/or monitor user activity (see Live Update™, a product of Symantic, Inc.) is well known.
The apparatus of a software agent executing upon a personal computing device communicating a captured user context to an internet-based advertisement server (see Ncase, a product of 180 Solutions, Inc.) is well known.
The apparatus of an integrated software component of a computer software application, executing upon a personal computing device, communicating a captured user context to an internet-based advertisement server (see Yahoo™ Search Engine, a product of Yahoo, Inc.) is well known.

The apparatus of an internet-based advertisement server selecting advertisements congruent with a supplied user context from an inventory of advertisements, and subsequently providing the selected advertisements to a software agent executing upon a personal computing device (see CNN.com™, a product of Time-Warner, Inc.) is well known.
The apparatus of an internet-based advertisement server selecting advertisements congruent with a supplied user context from an inventory of advertisements, and subsequently providing the selected advertisements to a computer software application executing upon a personal computing device (see various products of DoubleClick, Inc.) is well known.
The capability of many types of personal computing devices to receive digital advertisements over a network is well known, as is the capability of such devices to send and receive over a network digital objects of many formats, as is the capability of such devices to persist digital objects to non-volatile digital memory or to record digital objects on fixed or removable digital media. Such well known personal computing devices include, but are not limited to, desktop personal computers, laptop personal computers, personal digital assistants (PDAs), advanced display cellular phones, advanced display pagers, and advanced display text messaging devices.

The present invention differs from the prior art in that in all preferred embodiments, advertisements supplied from an external source are inserted into a routinely persisted output object of a computer software application, the addition of advertisements to the regular output content of the computer software application forming a “magazine”, wherein the regular output content of the computer software application takes the part that is routinely termed “editorial content” in printed magazines, and the inserted advertisements take the part that is routinely termed “advertising content” in printed magazines.

Within the scope of the present invention, the terms “digital object” or “output object” refer to any object which can stored, retrieved, transmitted, received, viewed, edited, or otherwise manipulated by computer application software (e.g. a “program”) on a computing device. The most well known digital object is a “file”, and the well known examples of files and file formats used by computer application software on personal computing devices are too numerous to make enumeration practical or necessary.

Within the scope of the present invention, the term “routinely persisted” refers to the disposition of an output object, that disposition being made by the user of a computer software application on a personal computing device at a time subsequent to the generation of the output object by the computer software application. In the well-known sequence, a computer software application is invoked by a user, and following completion of the program execution, an output object may or may not be generated. If the output object is, after review by the user, satisfactory in the opinion of the user, the output object may be discarded. Alternatively, the output object may be “persisted” or stored in non-volatile digital memory or stored on non-volatile digital media. Both anecdotal observation and commonsense dictate that the elapsed time and computing effort required to generate the output object will influence the user's decision to discard or persist a satisfactory output object. The term “computing effort” refers to how much of a specific computer's resources (examples include processor, memory, storage, bandwidth) were engaged to produce the output object. Therefore, those satisfactory output objects which require a significant commitment of time and computer resources to generate are more likely to be persisted, while those satisfactory output objects that can be quickly generated on demand may be more likely to be discarded.

In all preferred embodiments of the present invention, any personal computing device which has the capability to send and receive over a network digital objects of many formats, the capability to persist digital objects to non-volatile digital memory or to record digital objects on fixed or removable digital media can serve as the personal computing device required by the present invention. Such well-known personal computing devices are noted above.

In all preferred embodiments of the present invention, the digital output object of a computer software program is a document written in a presentation markup language such as HTML (Hypertext Markup Language), a successor language such XHTML, or one of the many evolving specialized variants of HTML, for example, but not limited to, HDML (Handheld Device Markup Language), WAP (Wireless Access Protocol), and WML (Wireless Markup Language). The operating systems and application software resident on many of the personal computing devices noted above provide features for automated or simplified translation from one variant of these well known markup languages to another.

In another preferred embodiment, an integrated software component of a computer software application, executing upon a personal computing device, inserts the advertisements supplied from an external source into a routinely persisted output object of a computer software application. In this embodiment, the integrated software component has an independent thread of control, and executes concurrently with other software components of the computer software application. It is this embodiment which realizes the improvement upon current adware technology, because the integrated software component is immune from removal by adware removal software such as Ad-Aware™, a product of Lavasoft, Inc.

In a third preferred embodiment, a collection of advertisements originating from external sources is persisted on the personal computing device, the collection being managed by the magazine software agent or by the magazine software component, the magazine software agent or magazine software component management of the collection taking the form of actions such as selecting members from the collection of advertisements to be inserted into the output object of a computer application, under the circumstance of such output object being generated without an available connection to the internet (i.e. off-line execution), or selecting members from the collection of advertisements to be inserted into the output object in preference to the advertisements most immediately transmitted from the internet-based advertisement server.

In a fourth preferred embodiment, the magazine software agent or magazine software component provides a Graphical User Interface (interface), and such interface is made available to the user of a personal computing device, so that the user can review, delete, or share specific advertisements that are members of the collection of advertisements. The interface could provide other features to the user, for example, but not limited to, setting a switch that would engage or suspend the magazine software agent or magazine software component behavior of inserting advertisements into the digital output object of a computer software application. The magazine software agent or magazine software component could, through the interface, provide a “filter” feature that permits the user to “profile” the types of advertisements to accept and/or persist when received from external sources, and would thereby permit the user to exclude (for example) advertisements for adult material, while including advertisements for (for example) children's learning products.

In a fifth preferred embodiment, an operating system such as Microsoft XP would create a category in My documents called, my magazine.

All ads deriving from enabled software could be shunted to that silo for later review if the user so wished.

The user can also select a switch where the ads are not just copied to My Magazine but rather moved to My Magazine.

This allows for user control for the final placement for the ads.

In a further preferred embodiment of the above, the OS can provide a facility which automatically handles all incoming documents where ads have been placed and shunt them, as per preference to MY Magazine.

Each placement in MY Magazine would be labeled as to source document.

In a preferred embodiment, advertisements originating from and/or supplied by external sources would be appended to the end of the digital output object of the computer software program.

In a preferred embodiment, advertisements originating from and/or supplied by external sources would be inserted into “points of division” or “breaks” in the content of the digital output object of the computer software program, such “points of division” or “breaks” being locations in the content such as, but not limited to, page breaks, chapter breaks, and section breaks.

In a preferred embodiment, the magazine software agent or the magazine software component would communicate to the internet advertisement server and/or insert advertisements into the digital output object of the computer software program based upon the most recently captured user context captured by the magazine software agent or the magazine software component.

In a preferred embodiment, the magazine software agent or the magazine software component would communicate to the internet advertisement server and/or insert advertisements into the digital output object of the computer software program based on one or more captured user contexts captured by the magazine software agent or the magazine software component and persisted to non-volatile digital media or non-volatile digital memory.

Because all preferred embodiments of the present invention require the routinely persisted output object of the computer software program to be a document composed in HTML or a successor or HTML variant markup language, the advertisements sent to the magazine software agent or the magazine software component must also be composed in HTML or a successor or HTML variant markup language. In many well known implementations of digital asset transmission, and specifically in the well known case of the digital asset being an advertisement, the advertisement server has knowledge of or can acquire knowledge of the type of personal computing device which is to receive the digital asset, and will select a version of the advertisement composed in the markup language optimized for use on the destination personal computing device. Where translation between markup language dialects is not automatic, the present invention will utilize existing software translation products to translate the supplied advertisement into the preferred format. Once translated into the preferred format, insertion of the supplied advertisements into specific locations in the regular content of the digital output object is a routine text manipulation operation.

In one embodiment, the output object composed in HTML or a successor or HTML variant markup language is output in addition to one or more other output objects of the computer software program, such other output objects being in any format.

In one embodiment, the advertisements sent to the magazine software agent or the magazine software component are limited to an HTML Anchor tag and an image, in which an image is the advertisement, and the HTML Anchor tag used to render the image “clickable”. An example of such an Anchor tag is, <A HREF=“advertisementserver.com/show_ad”><IMG RC=“advertisement.gif”></A>.

As noted above, persistent storage of documents composed in HTML or a successor or HTML variant markup language is well known, as is the recording of such documents on fixed or removable digital media. Once persisted, the magazine can be retrieved from the digital storage media at will, and thence reviewed, shared or re-stored using well known methods and mechanisms.

Sharing magazine documents will be enabled through existing and well-known methods and mechanisms. Magazines can be sent directly as HTML emails, as HTML document attachments to text emails, placed in shared folders, posted on web sites for download, and many other modes.

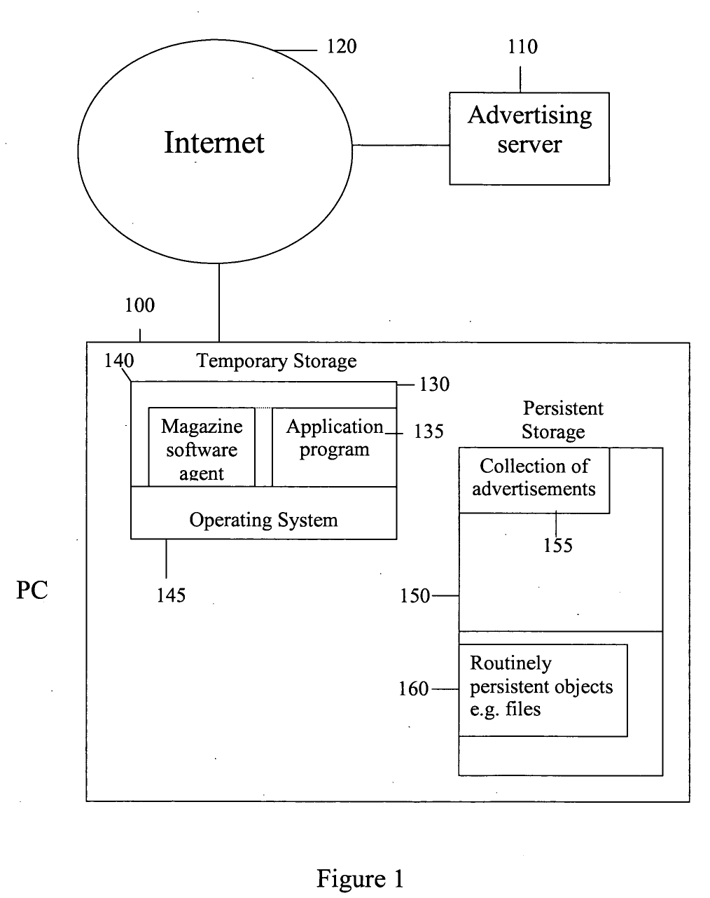

FIG. 1 shows an exemplary system for distributing advertising in accordance with one aspect of the invention in more detail. FIG. 1 shows a computer, such as a personal computer (100) connected by a communications link over a network, such as the Internet (120) and links to an advertising server (110). The computer has both temporary storage (130) in which programs operate and persistent storage (145) for storing data that will last beyond a particular session of an application program. The temporary storage houses an operating system (145) which supports the operation of application programs (135) to carry out functionality desired by the user. A magazine software agent (140), which can be either a stand alone process that runs concurrently with one or more applications or can be integrated with the application program (135) as indicated by the dash lines. If the magazine software agent is integrated as part of an application program, it operates on a separate thread.

Persistent storage (150) contains an area (160), which would typically be utilized to store persistent objects such as data files. Persistent storage (150) also supports storage of advertising content for incorporation persistently into the output of application programs as desired by the user.

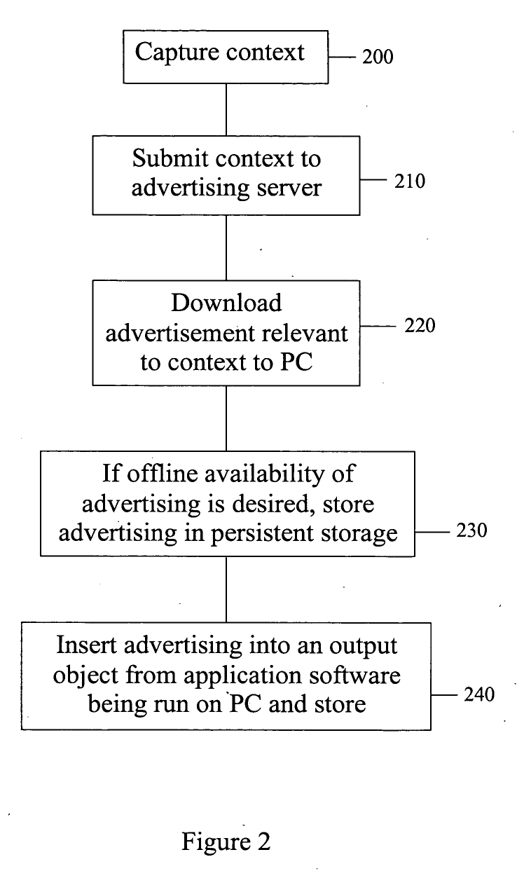

The operation of the system of FIG. 1 will be discussed more in detail in conjunction with FIG. 2.

FIG. 2 shows a flowchart of software used in accordance with one aspect of the invention. As discussed above, the context that a particular user is operating in is captured (200) and the context is submitted to an advertising server (210). The context will be utilized to retrieve from the advertising server advertising relevant to the context and that will be downloaded to the personal computer (220). If offline availability of the advertising is desired, the advertising will be stored in persistent storage (230). The downloaded advertising will be inserted into an output object from the application software that is executing on the PC (240).

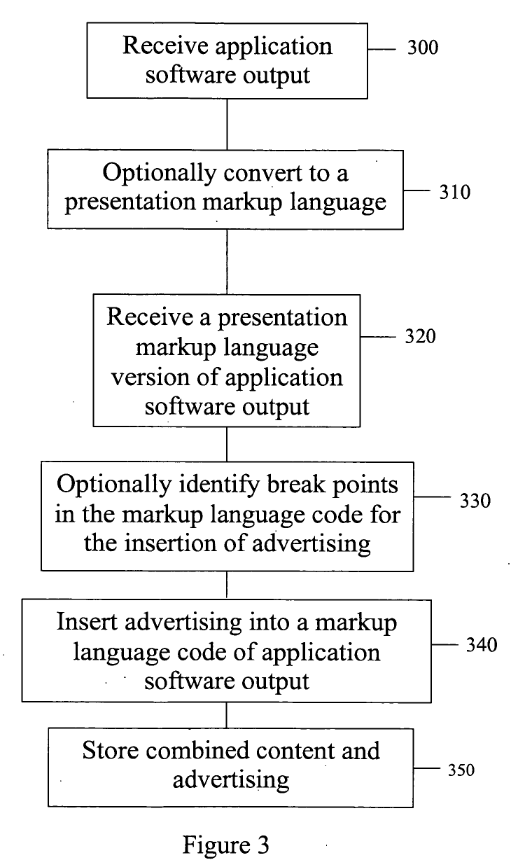

FIG. 3 shows a flowchart of software used to insert advertising into HTML output from an application in accordance with one aspect of the invention.

When output is received from application software (300), it is optionally converted to HTML (310) if it is not already in HTLM format. The HTML version of the application software output is in received (320) and analyzed, optionally, to identify break points in the HTML code for the insertion of advertising (330). When the break points have been identified, a decision will be made to insert the advertising into the HTML of the application software output, resulting in a merged application output information together with advertising (340). Optionally, the user can determine whether or not to store the combined content and advertising data (350).

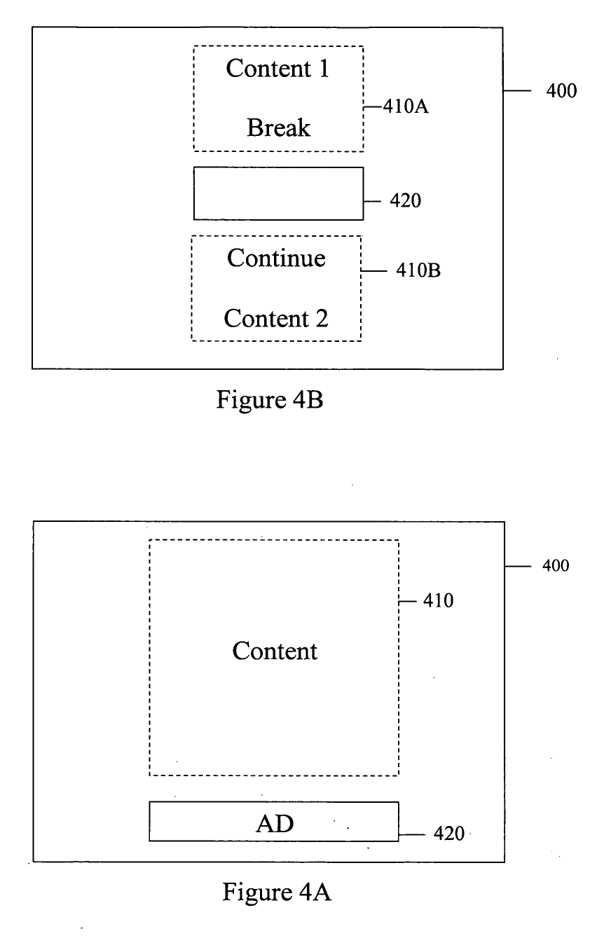

FIGS. 4A and 4B show alternative display options for displaying advertising. FIG. 4A shows an HTML page in which the output content from an application program (410) is displayed as it would normally be displayed in HTML format and one or more blocks of advertising HTML are inserted after the output of the application software to form a composite page having both content and advertising like a magazine page.

FIG. 4B shows an alternative arrangement on which one or more break points have been identified in the HTML output content of the application software and advertising, such as advertising HTML code (420) is inserted between segments separated by the break point. Thus, there will be two content areas (410A) and (410B) separated by advertising content (420).

Although illustrated in somewhat simplistic fashion, it is possible to identify and position the advertising text at any location on the output display page desired to give the same visual appearance and flexibility of format that could be found in a regular printed magazine page.

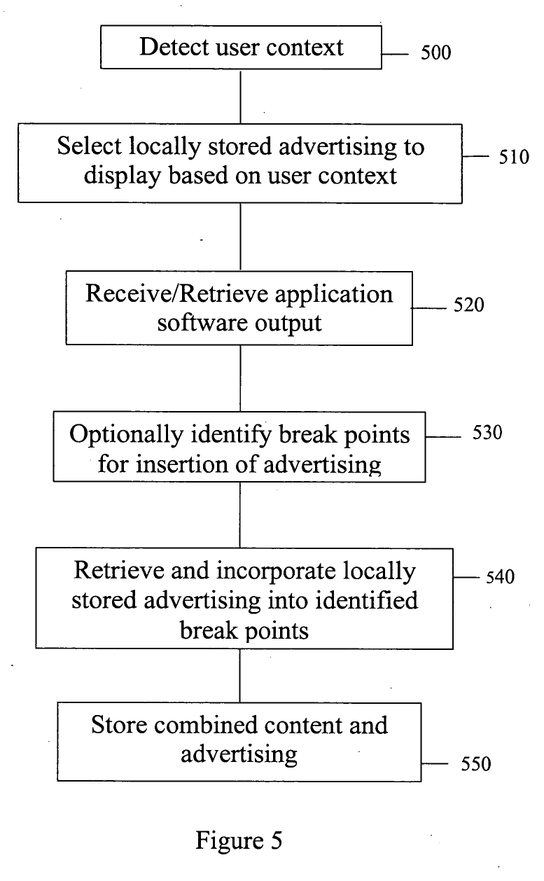

FIG. 5 shows a flow chart of software used to insert advertising into HTML output from an application that is offline in accordance with one aspect of the invention. As in FIG. 3, the user context is detected and utilized to select locally stored advertising to display based on user context (510). When one receives or retrieves application software output HTML (520), one optionally identifies break points in the application software output for insertion of advertising (530). The selected advertising from the locally stored advertising is retrieved and inserted into selected break points (540). If the user desires, the combined content and advertisement magazine page composed as represented in the merged HTML code can optionally be stored for later use.

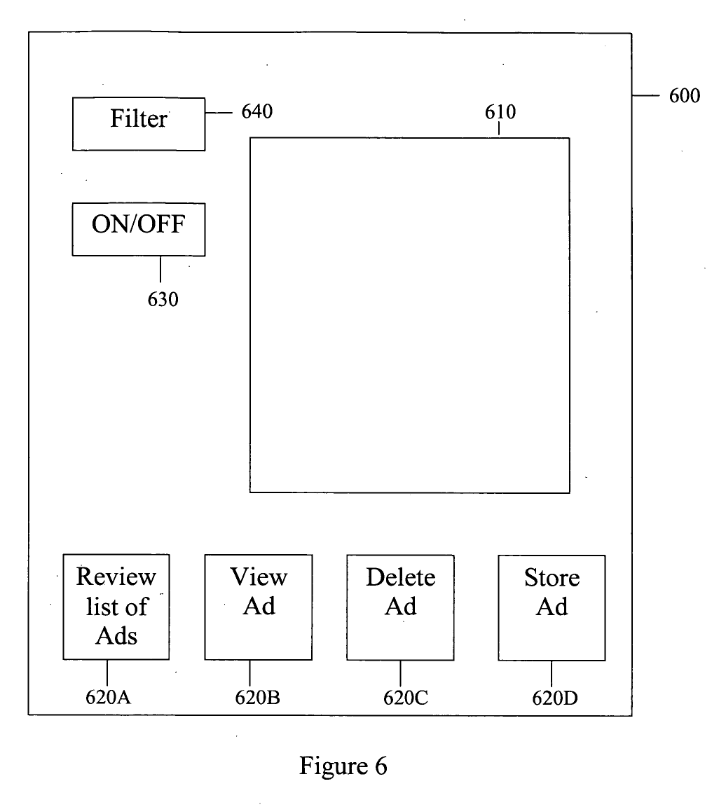

FIG. 6 shows an exemplary graphical user interface for use in accordance with one aspect of the invention. The physical display screen (600) can be partitioned into a number of areas. A virtual display area (610) can be utilized in conjunction with the various function buttons (620A, 620B, 620C and 620D). Other buttons may be utilized to suit the user convenience. Thus, when a user wishes to review a list of adds currently stored on the local computer, the user may do so by activating virtual button (620A). Activating a button can be done by clicking on the area or otherwise selecting the area for activation. If a particular list of advertising is displayed in window (610) in response to activation of the button (620A), a user may select one or more of the advertising files displayed there to view in detail within the viewing area (610). Optionally, the advertisement can be displayed on a full screen basis using all of display (600).

If the particular advertisement does not appeal to the user and he desires to delete it he may do so using the delete advertising button (620C). If a user desires to share the add with another user, the user can select button (620D).

The user has the option of turning off the display of any advertising (630) or allowing it to continue to be presented. The filter button (640) allows a user to view filter set up information on the virtual screen (610) so that filters can be configured to selectively block advertising that the viewer would consider objectionable.

While various embodiments of the present invention have been illustrated herein in detail, it should be apparent that modifications and adaptations to those embodiments may occur to those skilled in the art without departing from the scope of the present invention as set forth in the following claims.

What is claimed:

1. A method for making advertising available to users, comprising the steps of:
a. detecting context of a computer's use;
b. downloading advertising from a server, based on said context, to said computer;
c. incorporating downloaded advertising into the output from an application process and storing the output with the advertising embedded.

2. The method of claim 1 in which detecting context comprises one of:
a. capturing program arguments entered by a user;
b. by monitoring a user's activity with an application process;
c. by capturing keystrokes of a user;
d. by utilizing information available from advertisers;
e. by using a software agent running on said computer; and
f. by entry of information about a user by a user

3. The method of claim 1 in which downloading advertising content from a server based on context comprises:
a. sending context information to a server;
b. retrieving advertising at said server based on said context information;
c. transmitting retrieved advertising to a computer that provided the context information.

4. The method of claim 3 in which retrieved advertising received at a computer is stored for later use when a computer is offline.

5. The method of claim 1 in which the step of incorporating downloaded advertising as part of output from an application process comprises the step converting the output from an application process into a presentation markup language.

6. The method of claim 5 in which the presentation markup language is one of HTML or an HTML variants.

7. The method of claim 6 in which the downloaded advertising content comprises a document in a presentation markup language.

8. The method of claim 7 in which the downloaded advertising content is placed within the presentation markup language code of the output from the application process.

9. The method of claim 1 in which the downloaded advertising content is placed just before ending statement of the presentation markup language code or just after the beginning statement of the presentation markup language code.

10. The method of claim 1 running as a stand alone process on a computer.

11. The method of claim 1 running as an integrated part of said application process.

12. The method of claim 1 in which the step of downloading advertising from a server occurs while the computer is connected and the step of incorporating downloaded advertising as part of output from an application process occurs while the computer is not connected to a network.

13. A method comprising the step of transferring advertising content embedded in the output of an application process over a network.

14. The method of claim 13, in which the advertising content embedded in the output of an application process is stored on a server.

15. A method comprising the step of embedding advertising content in the output of an application process and storing said output with embedded advertising.

16. The method of claim 15 in which the step of creating comprises embedding advertising content in a presentation markup language format into an output from an application process.

17. A computer program product, comprising:
a. a memory medium; and
b. instructions stored on said memory medium for controlling a computer to perform the steps of:
b1. detecting context of a computer's use;
b2. downloading advertising from a server, based on said context, to said computer;
b3. incorporating downloaded advertising as part of output from an application process; and
b4. storing said output with incorporated advertising.

18. A computer program product, comprising:
a. a memory medium; and
b. instructions stored on said memory medium for controlling a computer to embed advertising content into an output from an application process and to store the output with the embedded advertising.

19. Computer apparatus comprising:
a. a mechanism for detecting the context in which said computer is being used;
b. a mechanism for requesting advertising content related to said context; and
c. a mechanism for incorporating downloaded advertising as part of output from an application process; and
d. storing said output with incorporated advertising.

20. The computer apparatus of claim 19 connected to one or more computers by a network.

21. A graphical user interface comprising:
a. a display area;
b. a control for selectively displaying one of files containing advertising content or advertising content from a selected file; and
c. a control for selectively enabling the insertion of advertising content into the output of an application process and for storing said output with embedded advertising.
